(19) United States
(12) Patent Application Publication
(10) Pub. No.: US 2008/0101899 A1
(43) Pub. Date: May 1, 2008

(54) Refuse or recycling cart lifting and transporting device

(76) Inventor: Stacy Evan Slonecker, Springfield, OR (US)

Correspondence Address: Stacy E. Slonecker, 35885 Campcreek Rd, Springfield, OR, 97478, US

(21) Appl. No.: 11/588,636

(22) Filed: Oct. 27, 2006

(51) Int. Cl. B60P 9/00

(52) U.S. Cl. 414/462

(57) ABSTRACT

A manually operated lifting and securing device for transporting loaded or unloaded wheeled refuse or recycling containers with the use of a common trailer hitch and a motor vehicle. The device utilizes the length of the cart itself as a lever, permitting a fully loaded cart to be lifted and secured with minimal effort.

A pivoting, adjustable, removable and specially slotted lift tube allows any size container that incorporates a lift bar to be easily fitted to the device and to trailer hitches of various heights. The device includes a two stage failsafe locking/unlocking mechanism that firmly secures the container and also permits easy release for safe removal. The device can be installed or removed from a trailer hitch quickly, without tools and stored in a compact space.

References Cited
U.S. PATENT DOCUMENTS

| | | | |
|---|---|---|---|
| 5,961,272 | Oct. 05, 1999 | Short | 414/462 |
| 6,164,896 | Dec. 26, 2000 | Cummins | 414/462 |
| 6,361,264 | Mar. 26, 2002 | Guthrie | 414/462 |
| 6,698,995 | Mar. 02, 2004 | Bik | 414/462 |
| 2005/0161906 (abstract) | | Thelen | 280/504 |

### BACKGROUND OF THE INVENTION

1. Field of the Invention

This invention relates generally to the field of container lifting and transporting and more particularly to a device mounted on a trailer hitch for lifting and transporting wheeled residential refuse and recycling containers.

The majority of household waste and recycling containers are now wheeled cart containers that household residents are responsible for transporting to the curb each week for pickup. Although these containers are generally convenient for use on smooth, hard, short and level driveways, many homeowners are confronted with driveways that are steep, soft, rough, extremely long or are a combination of these. For homeowners without ideal driveways, attempting to wheel a heavily loaded 30 to 95 gallon container to the curb can not only be arduous, time-consuming and cumbersome, but in some cases dangerous.

2. Overview of Prior Art

Although numerous patents have been filed concerning the lifting and transporting of various containers and receptacles, including trash and refuse containers, few have addressed the specific issues concerning homeowners lifting and transporting wheeled residential refuse and recycling containers.

U.S. Pat. No. 6,164,896 to Robert L. Cummins discloses an articulated, spring loaded, lever-action trash container-lifting device. Although the complicated device employs springs and levers, because the device dead lifts a loaded container vertically, apparently a great deal of arm strength is needed to successfully raise a fully loaded container. Because the device installs into a trailer hitch receiver, use requires reaching or bending under the vehicle, aligning the device to the receiver and installing or removing a locking pin and clip. Because this awkward procedure involves working under a dirty car or truck in all kinds of weather and light is not an optimal method.

U.S. Pat. No. 6,361,264 to Shawn Allen Guthrie, Tommy Lee Buffington and Arthur L. Tucker discloses a transporter that includes a lifter. The device employs a series if pulleys wheels and levers to also vertically dead lift a loaded container. In addition to being complicated and bulky the device also relies on arm strength for lifting. This device also installs into a hitch receiver and has all of the drawbacks mentioned above.

U.S. Pat. No. 6,698,995 (amended application filed Dec. 19, 2003) to Russell J. Bik and William J. Kelly discloses a crank operated container transporting device that relies on a on a cranking mechanism to lift a refuse cart vertically. The device is shown with a hand crank that would not only require considerable hand and arm strength to operate but would also be slow. One drawing shows a motor mounted in place of the hand crank to presumably to rectify these shortcomings but would unfortunately add the disadvantages of greater weight, expense and the need to connect to a power source. This machine also installs into a hitch receiver, with the above mentioned problems.

Brian L. Thelen, Waukesha, Wis. in Pub. No.: US 2005/0161906 describes a device for towing a wheeled refuse container by use of an attachment to a trailer hitch. Although this device would eliminate the difficulty of lifting a loaded refuse container, it supposes that the narrow hard plastic bearing less wheels typically used on refuse containers are robust enough to be towed by a motor vehicle. Although perhaps practical for towing at low speeds on hard, smooth surfaces for short distances the device would not be practical for use over rough or soft or long driveways.

Russell J. Short, Scott's Valley, Calif. in U.S. Pat. No. 5,961,272 describes a compact carrier for lifting and securing a waste receptacle that is small and compact with few moving parts. The device does have three major drawbacks however. First, since the device is attached under the trailer hitch ball, utilizing the bolt that secures the ball, it is necessary to use a large wrench, some force and time to remove and reinstall the ball each time the device is to be used. Secondly, since the height of the lever arms that receive the lift bar of the receptacle cannot be adjusted, it may be necessary to purchase and install an accessory to either raise or lower the height of the hitch ball in order correct any mismatch between the height of the device the receptacle lift bar. This height adjustment may then not be correct for towing the various trailers the owner may have thus requiring readjusting the height of the trailer ball each time a trailer is to be towed. Finally, the release mechanism that must be tripped to lower the receptacle cannot be reached while supporting the receptacle. If the vehicle is not perfectly level when the release is tripped, a heavy, loaded, waste container could suddenly and dangerously fall from the device.

### SUMMARY OF THE INVENTION

After much research and study of the above described problem, the present compact, light, and simple invention, which can be attached and removed without tools, has been developed to provide a means by which consumers can, with the use of a trailer hitch and a motor vehicle, easily lift and transport their loaded or empty household waste and recycling containers, long distances over rough or soft ground and/or steep grades, conveniently, safely and efficiently.

A hitch mountable household refuse and recycling cart lifting and transporting device, constructed either partly or completely of metal, polymer or composites, incorporating a removable, adjustable and slotted lift tube, a pivoting mechanism that attaches the lift tube to a trailer hitch and a securing locking/unlocking mechanism.

### BREIF DESCRIPTION OF DRAWINGS

FIG. 1. is a side elevational view of a wheeled waste container mated to the present invention which is installed on a receiver hitch, attached to a motor vehicle, ready to lift and lock;

FIG. 2. is a side elevational view of a wheeled waste container mated to the present invention which is installed on a receiver hitch, attached to a motor vehicle, in the loaded and locked position;

FIG. 3. is a side elevational view of the present invention in a locked upright position without a waste container;

FIG. 4. is a side front elevational view of the present invention showing the device and four sets of the many lift tube adjustment holes;

FIG. 5. is a top elevational view of the present invention;

FIG. 6. is a side elevational detail view of a cart lift bar in position to slide into the notch of the lift tube;

FIG. 7. is a side elevational detail view of a cart lift tube in an upright position with the cart lift bar fully inserted into the notch of the lift tube;

FIG. 8. is a detailed perspective view of the two stage locking mechanism in the locked loaded position;

FIG. 9. is a detailed perspective view of the two stage locking mechanism in the 90 degree handle rotation, lock bolt receded slightly position;

FIG. 10. is a detailed perspective view of the slide ramp in locked position;

FIG. 11. is a detailed perspective view of the slide ramp in position to push and retract the lock bolt;

FIG. 12. is a detailed perspective view of the two stage locking mechanism in the unlocked, latched position, ready to rotate.

### DETAILED DESCRIPTION OF THE REFUSE OR RECYLING CART LIFTING AND TRANSPORTING DEVICE

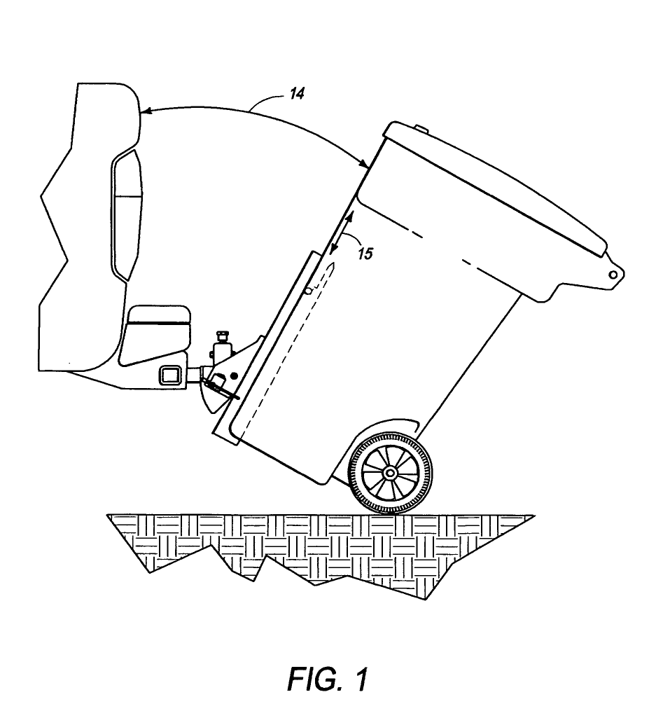

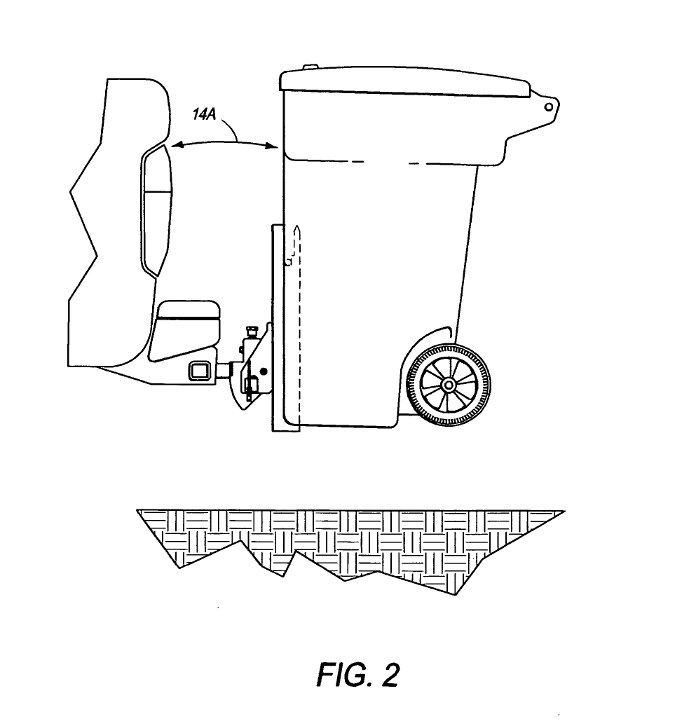

In reference to the drawings (FIG. 1), what is shown is the operation of the Refuse or Recycling Cart Lifting and Transporting Device. This device is manually operated, self-latching, and enables a person to easily lift and secure a wheeled refuse or recycling cart to a motor vehicle for transport. To use, a wheeled refuse or recycling cart (such as those typically use by households) is pushed on to the height-adjustable lift tube and levered upward (arc number 14) to the locked transport position shown in FIG. 2. The device's latch and lock mechanism locks automatically, but is also designed to work as a fail-safe mechanism that prevents accidental release, yet allows the refuse cart to be released and off-loaded easily and safely at will. The Refuse or Recycling Cart Lifting and Transporting Device is designed to be compact and lightweight, so as to make the device easy to install, remove, use, and store.

### Detailed Description of Operation of the Latching and Releasing Mechanism

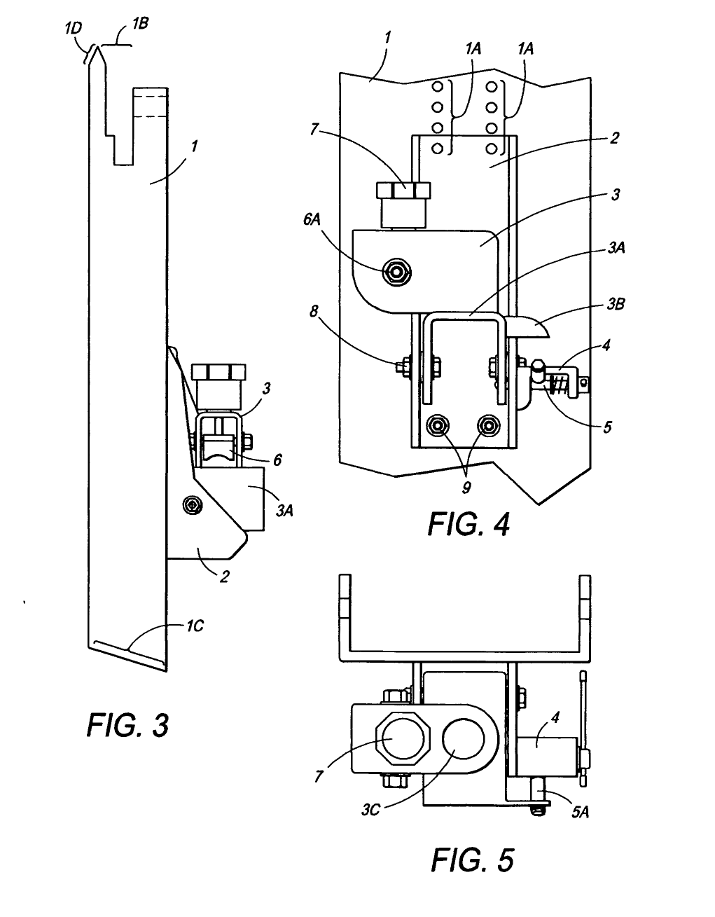

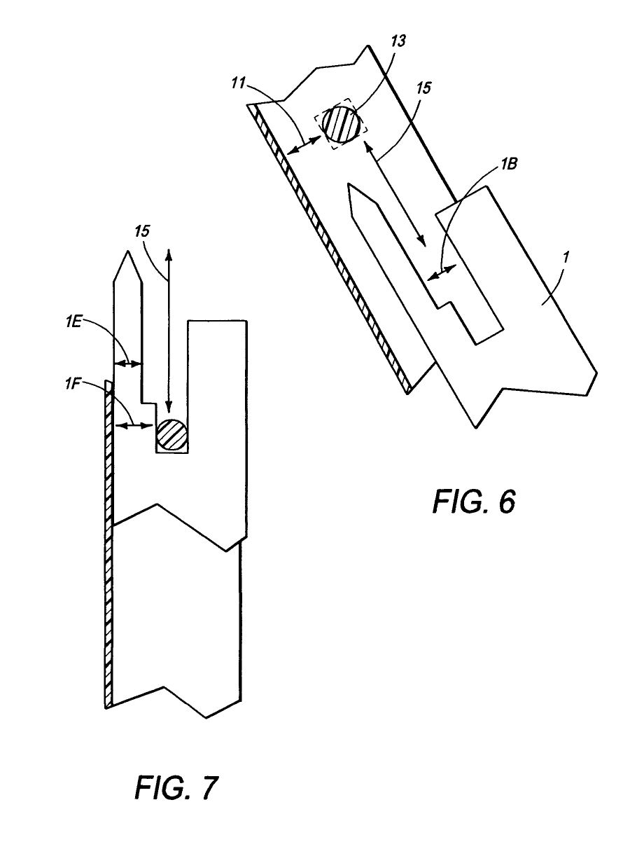

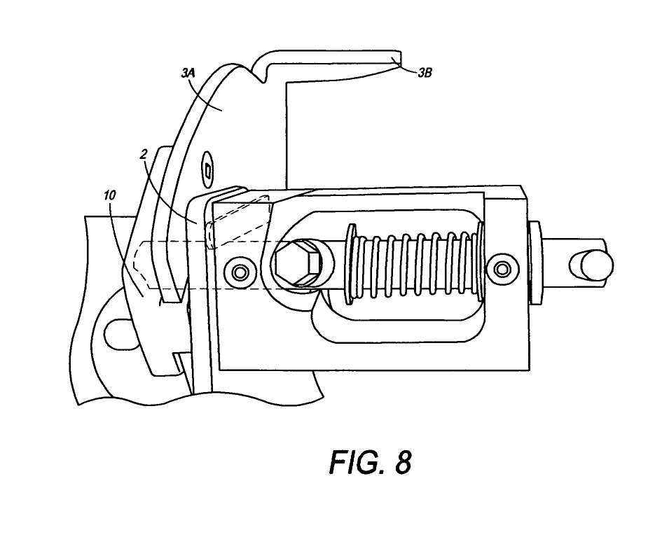

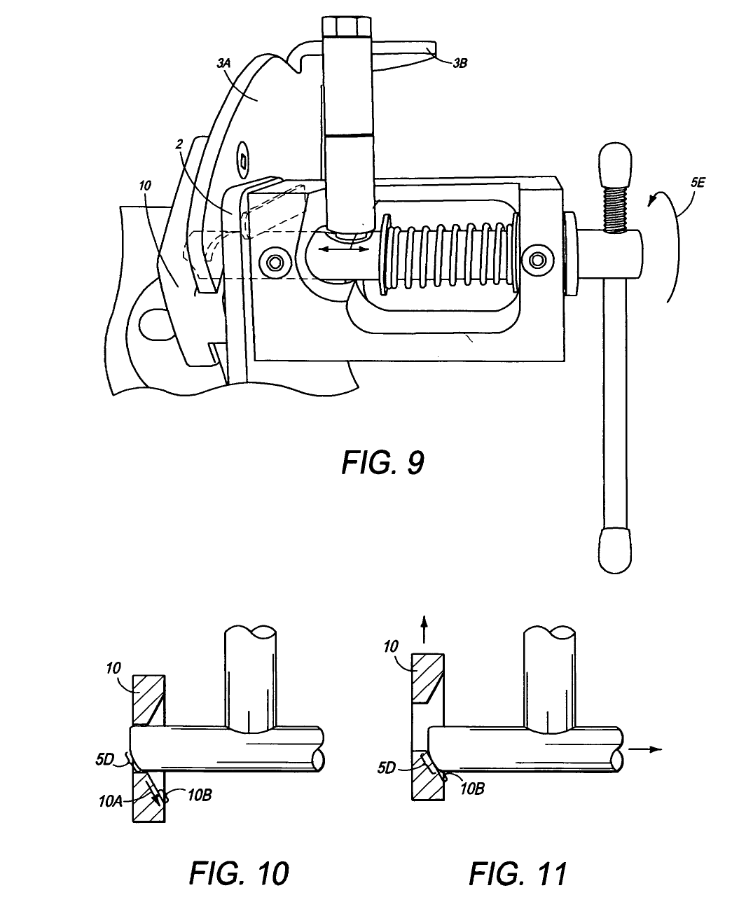

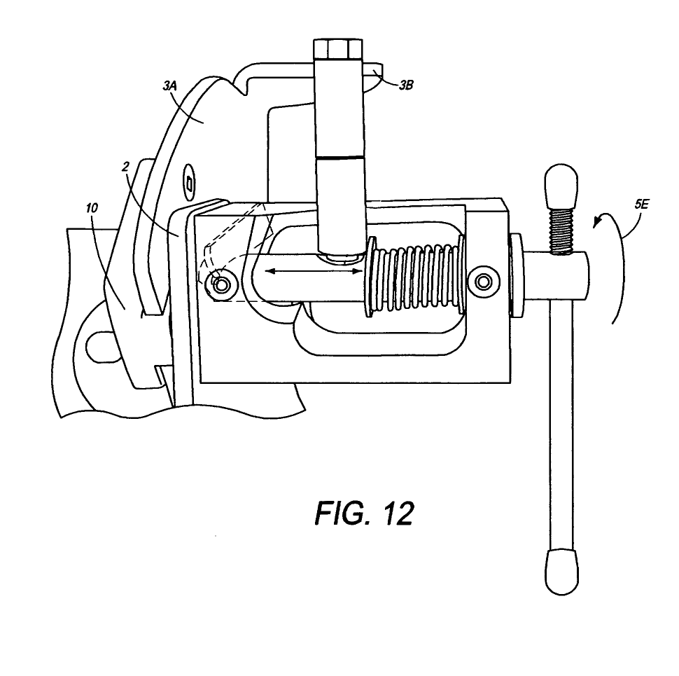

After placing the Refuse or Recycling Cart Lifting and Transporting Device onto a vehicle mounted receiver style trailer hitch ball, the device is secured to the ball by turning the device's hitch lock handle clockwise until it is tight. A refuse cart is rolled forward and pushed onto the height-adjustable lift tube shown in FIG. 6, Number 1, and the cart's lift bar is slid into the slot at the top of the lift tube. After insertion of the cart's lift bar (FIG. 6, Number 13) the cart and the lift tube become mated (FIG. 7, Number 15) in such a way that pushing and lifting the cart rotates the lift tube channel (FIG. 3, Number 2) and the cart together. The Cart and the lift tube assembly pivots (FIG. 4, Number 8) on an arc (FIG. 1, Number 14) up towards the automatic lock position. When fully upright, the latching mechanism (FIG. 8) forces by spring action, (Number 5B) the locking bolt (Number 5) into the tapered locking plate, (FIG. 9, Number 10) securing the refuse cart to the device and the vehicle. After transporting the refuse cart to the desired location, the operator will move the handle (FIG. 8, Number 5C) clockwise approximately 90 degrees (arc number 5E) to a stop location where bolt arm 5A comes into contact with the lock bolt housing (Number 4). This positions the tapered end of the locking bolt (Number 5) so that the tapered angle of the bolt end (Number 5D) and the tapered ramp angle (FIG. 11, Number 10A) are parallel. When the device is in this configuration the cart is still securely locked upright and the operator can walk to the back of the cart to obtain a firm grip. As the operator pushes the refuse cart forward towards the vehicle to unlock the mechanism, (FIG. 2, arc number 14A) the bolt comes in contact with the tapered locking plate (FIG. 11, Number 10) and the rotational force applied by the operator is transferred to the bolt and the locking plate which (Number 10A) slides and moves the bolt horizontally into the locking mechanism housing (Number 4). This action compresses the spring (FIG. 9, Number 5B) until it reaches full compression at position 10B on the tapered locking plate (Number 10). At this point of greatest insertion of the locking bolt into the locking mechanism housing, a slot in the locking bolt comes into position for the spring (FIG. 10, Number 12A) loaded blade catch (Number 12) to enter this slot by arc Number 16 and hold the bolt, preventing it from making contact with the tapered locking plate and returning to the locked position. At this position, the operator of this device can begin to manually lower the refuse cart. As the device is being lowered, the lock reset tab (FIG. 4, Number 3B) on receiver ball pivot channel (Number 3A) comes in contact with bolt arm (FIG. 9, Number 5A) and forces the locking bolt to pivot on axis approximately 90 degrees. As the bolt is being pivoted, the slot that is housing the spring loaded blade (FIG. 10, Number 12) rotates such as to dislodge the blade on arc Number 16 from the bolt that was once being prevented by the blade from plunging toward the receiver ball pivot channel (FIG. 4, Number 3A). As the blade is dislodged, the spring loaded bolt end (FIG. 9, Number 5D) comes to rest against receiver ball pivot channel (FIG. 11, Number 3A) with high spring pressure. At this point, the refuse cart wheels will be on the ground at rest and the cart can then be disengaged from the device by rolling the cart backwards away from the vehicle. The cart can then be positioned at curbside for refuse pick-up service. The Refuse or Recycling Cart Lifting and Transporting Device at this time will be in a down, ready-to-load, non-locked position. This position is ready for tilt up and auto lock. In this position, the lock bolt (FIG. 11, Number 5) is being forced against receiver ball pivot channel (Number 3A) by spring pressure. (FIG. 9, Number 5B). As the receiver ball pivot channel Number 3A is rotated, the tapered locking plate female receptacle (FIG. 11, Number 10) is brought into alignment by arc Number 11 so as to allow the male receptacle locking bolt to relieve spring pressure and to force its way into the hole in the tapered female receptacle locking plate Number 10, locking the cart lifter into the up position for transporting a refuse cart storage or for storage when removed from the vehicle.

### Attaching Mechanism to Vehicle Trailer Hitch Ball

This Refuse or Recycling Cart Lifting and Transporting Device has been designed for quick and easy attachment and detachment from any transporting vehicle that uses an existing trailer ball on a receiver-type hitch. This mechanism is designed to be simply placed onto a standard receiver type hitch ball and then secured by rotating the ball lock handle clockwise until it is tight. To remove, the reverse procedure is employed. The device is lightweight and compact so as to make the Refuse or Recycling Cart Lifting and Transporting Device easy to install and remove.

### Detailed Description of the Operation of the Attaching Mechanism

The operator of this device would simply lift the device with one hand on the top of the lift tube/channel (FIG. 3 number 1B) and the other hand on the knob (FIG. 5 number 7). Then set the unit onto the ball and receiver through the hole in the top of the ball receiver pivot channel (FIG. 4, Number 3A), while viewing the process through the inspection hole (FIG. 5, Number 3C). At this time, the unit is sitting on the receiver (FIG. 2), but without a refuse cart. The inspection hole (FIG. 5, Number 3C) will be close to flush with the top of the trailer ball and the top of the receiver ball channel will be sitting on the top of the vehicle's receiver unit around the base of the trailer ball. From this position, the operator will grab the loosening/tightening knob (FIG. 5, Number 7) and turn it clockwise to tighten the unit to the ball and receiver hitch.

The knob, (FIG. 5, Number 7) is threaded onto a bolt that is held by a pivot fork (FIG. 3, Number 6). As the knob is tightened, the bolt lifts a pivot fork, that is anchored on one end by an axel that attaches to each side of the ball housing (FIG. 3, Number 3), but allows the opposite end of the pivot fork (FIG. 3, Number 6) to be lifted/pivoted upward. The edge of the pivot fork farthest from the axel shaft (FIG. 3, Number 6) has formed within it, a half spherical depression that when lifted by the treaded knob bolt, comes in tight contact with the bottom of the trailer ball. As the knob is tightened, more force is applied to the bottom of the ball by the pivot fork which forces the top of the receiver ball channel downward (FIG. 4, Number 3A), tightly pressing it against the top of the receiver hitch around the base of the ball. By rotating the ball lock hand knob counter-clockwise the device can be loosened and easily removed.

### Lift Tube Pivot Mechanism Detailed Description

The lift tube pivot channel (FIG. 3, Number 2) is designed to be attached by mechanical, adjustable, means to the lift plate/tube. This design allows various lift tube height adjustments and permits the use of different lift plates/tubes designs in order to fit any style of wheeled refuse cart incorporating a crossbar. The lift tube pivot channel is constructed so that one of the channel sidewall extends above the height of the other channel sidewall and attaches to the locking mechanism. The shared pivot points on each sidewall are directly across from each other and the same perpendicular distance from the channel base (FIG. 4, Number 8) The locking mechanism (FIG. 8) has a plunger (locking bolt) to hold the lift tube channel (FIG. 4, Number 2) and the receiver ball channel (FIG. 4, Number 3A) in a static position when the Refuse or Recycling Cart Lifting and Transporting Device is in a locked upright transporting mode. The receiver ball pivot channel (FIG. 4, Number 3A) is narrower in width than the lift tube channel (FIG. 4, Number 2) so as to pivot inside of it (FIG. 4). The receiver ball pivot channel attaches to, or is integrated with, the ball/hitch locking mechanism and the ball housing, and is involved in securing the device to the receiver hitch by making tight contact against the top face of the receiver. This channel also has the lock reset tab (FIG. 4, Number 3B) that pushes against the locking bolt arm when the lift tube is being lowered pivoting the locking bolt (FIG. 4, Number 5) out of free-pivot position to the up and locked position. The receiver ball channel also contains a sloped locking plate on the same wall as the lock reset tab. This locking plate is ramped, to force the pre aligned locking bolt back into the latched free-pivoting position when the lift tube channel is rotated, and also includes the hole that the lock bolt plunges into, preventing the two channels from pivoting.

### Lift Plate/Tube Mechanism Detailed Description

Most household refuse carts in use today, are of the type shown in FIG. 1. About midway up the side of the cart that opposes the wheels, is a crossbar that extends from one side of a recessed channel slot to the other. This recessed channel and crossbar in the refuse cart is shown in FIGS. 2, 6 and 7. The lift channel/tube (FIGS. 3, 6 and 7, Number 1) is designed to slide into and mate tightly with many styles of refuse carts so that when mated, (FIG. 1) lifting forward and upward on the refuse cart, creates a fulcrum lever action utilizing the cart axis (pivot FIG. 4, Number 8) and cart length to provide lifting leverage. This allows one to raise and lock, a heavy cart up off the ground, with minimal effort. Since refuse cart crossbar height, depth, style, size and construction material varies from brand to brand the Recycling Cart Lifting and Transporting Device has a specially designed lift channel/tube that fits most refuse carts and vehicle hitch heights and can be reconfigured for unusual or unanticipated cart configurations. An important feature of this lift channel/tube is the crossbar opening design (FIG. 6, Number B). This stepped design allows a multitude of carts to be loaded and mated tightly. A cart with a crossbar in a shallow recessed channel will be able to load in on the first step (FIGS. 6 and 7, Number 15) and come to rest at the bottom of this step. A cart with a deeper recess will load in on the first step and then fall deeper into the second step and come to rest at the bottom of it. The majority of all carts used in use today will mate effectively with this configuration. An additional feature of this lift channel/tube is that since it is mechanically fastened to the lifting/locking mechanism, if an unusual style refuse cart does not fit tightly in a certain lift tube style, the only item needing to be changed is the lift tube rather than the whole refuse cart lift and transport device. This would enable manufacturers of the Recycling Cart Lifting and Transporting Device to adjust to evolving wheeled cart designs or move into markets with unique cart or unforeseen designs. An additional feature of this lift channel/tube is the multiple adjustment holes (FIG. 4, Number 1A) use for fastening the lift tube to the lift tube pivot channel. (FIG. 4, Number 2). These holes allow the height of the lift tube to be adjusted relative to the ground. Owners with vehicles with either high or low hitch heights can easily adjust the device for optimal use. Further, the device can be switched and adjusted for use on more than one vehicle. A final feature of note of this lift tube is the surfaced end opposing the cart-loading slot. This end angle is designed so that when the Recycling Cart Lifting and Transporting Device is not in use, it can be set on a flat surface and will stand upright, facilitating easy pickup and allowing upright storage, using less space.

### Loading Slot Design in Lift Tube Detailed Description

The configuration of the loading slot in the lift tube/channel (FIG. 6, Number 1) accomplishes loading and unloading most refuse/recycling wheeled carts that incorporate a lift bar. (FIG. 6, Number 13) (FIG. 1) The unique shape of the loading slot in the lift tube/channel (FIG. 6, Number 1) and the configuration of the lift tube that surrounds it are essential for the smooth but secure mating of the most common designs of household wheeled waste carts, to the cart lifter/transporter. The leading edge of the loading entry opening of the lift tube slot has a knifed or wedge shaped edge. (FIGS. 3, 6 and 7). The outer leading edge of this wedge (FIG. 3, Number 1D) accomplishes self-alignment of the lift tube with the cart lift bar. The angle of this wedge permits the lift tube to slide easily upward during loading (FIG. 6, Number 15) rather than dead-ending (digging) into the body of the cart and stopping the forward momentum applied to the cart. Because of this design, the carts will smoothly load onto the lift and transport device at various cart approach angles. When the leading edge of this wedge makes contact with the cart, (FIG. 6, Number 13) under the crossbar, the inside top of the wedge face also makes contact with the lift bar of the cart. This wedge angle forces or deflects the lift tube into the gap between the lift bar and the cart body, and with the forward motion of the cart forces the lift tube to align itself (mate with) the surface of the recessed channel in the cart body. At this point, the lift tube and the cart are parallel and the cart lift bar will slide down the slot in the lift tube and fully embody itself in the recess of the cart (FIGS. 1, 2 and 7). The distance between the lift bar of the cart and the bottom of the recessed channel (body of cart) varies from brand and style of cart. This distance or gap between the lift bar and the cart body typically falls into two categories, a shallow gap and a deep gap style. When loaded into the lift tube, the shallow gapped cart lift bar comes to rest at the bottom of the first step of the lift slot (FIG. 6, Number 1B). A deep gapped cart comes to rest at the bottom of the second step. This creates a tight fit between the lift tube and the cart body regardless of which type of cart is loaded. Now that the cart and the lift tube are mated, pushing slightly upward (FIG. 1, Arc Number 14) rotates the cart and the lift tube as one unit. This levering action pivots off of an axle point (FIG. 4, Number 8) through the bodies of the lift tube pivot channel (FIG. 4, Number 2) and the ball hitch pivot channel (FIG. 4, Number 3A). This feature of the lift tube is very important for reduce the force necessary for rotating and lifting the cart onto the lift and transport device. The lift tube locks securely against the cart body, so that pushing and slightly lifting the cart by its handle does not allow the cart to rotate around the lift bar axis. This type of rotation (at the lift bar) is a fault of other devices. This causes the cart bottom to rotate toward the operator and causes the operator to have to balance and dead-lift the cart's weight. This inefficient motion increases the degree of difficulty the operator has in getting a loaded cart up off the ground and onto a device for transport, and increases the danger and difficulty of off-loading a heavily loaded cart.

### Two Stage Lock Detailed Description

The ramped locking plate, with its corresponding slanted locking bolt, is a unique feature of the fail-safe, two-stage locking mechanism. This ramped plate, allows the operator of the mechanism to unlock and lock the device using a very short rotational arc while in a safe position with a firm, controlled grip on the refuse/recycling cart. The ramped locking plate is of a material that is low in frictional coefficient so as to let other materials rotate and slide easily on its surface. When the lift and transport device is in a locked and transport mode, the locking bolt (FIG. 4, Number 5) is fully inserted through the hole in the center of the tapered locking plate (FIG. 10, Number 10). This is the position where the bolt is at its farthest penetration through the ramped locking plate (first stage of lock). As the bolt is rotated approximately 90 degrees by the operator, using a handle on the opposite end of the lock bolt (FIG. 9, Number 5E). This rotation causes the bolt to retracted slightly from locking plate by the motion of the bolt arm traveling and rolling on a ramp that is formed into the latching mechanism housing (FIG. 9, Number 4) In this position, the slanted face of the bolt and the ramp of the locking plate are in contact at the lowest point of the ramp. The refuse/recycling cart is being held upright and still locked from pivoting down (second stage). Now as the cart is pushed slightly toward the vehicle (FIG. 2, Number 14A), this action forces the angled surfaced bolt to slide up the tapered ramp, (FIG. 10, Number 10A) and recede into the latching mechanism housing. When the bolt reaches its deepest point of retraction Number 10B), the bolt is locked into place by a lock blade and kept from rebounding back into the hole, (FIG. 4, Number 3A) allowing the lift plate pivot channel to pivot. As the cart is unloaded from the lift and transport device, the bolt arm (FIG. 5, Number 5A) is forced to rotate approximately 90 degrees by the pivot tab (FIG. 4, Number 3B). This action dislodges the locking blade from the bolt and the bolt is forced by spring action against the ball hitch pivot channel (FIG. 4, Number 3A). As the lift tube/channel on this device is rotated up for lock and transport mode (FIG. 1, Arc Number 14), the end of the locking bolt is sliding along the ball hitch pivot channel. Toward the end of the rotation, the bolt comes into alignment with the recessed ramp leading to the locking hole in the tapered locking plate. The spring loaded locking bolt travels down the ramp and is secured in the hole at the bottom of the ramp.

This places the lifting and transporting device back in the first stage secure lock mode.

What is claimed:

1. A household wheeled waste/recycling cart lifting and transporting device for use in conjunction with a receiver type trailer hitch, a ball mount, and a hitch ball comprising:
Any device or mechanism used to lift and transport household waste/recycling wheeled containers that can be connected or attached to, and then removed from, a receiver type trailer hitch ball or ball mount without the use of tools.

2. A household wheeled waste/recycling cart lifting and transporting device for use in conjunction with a receiver type trailer hitch, with or without a ball mount, and with or without a hitch ball comprising:
Any device or mechanism used to lift and transport household waste/recycling wheeled containers that employs a failsafe locking mechanism requiring a two-stage release/unlocking procedure. In the first step, the operator manually pre-sets the device for unlocking and then applies pressure or force on the mounted container to complete the second stage, unlocking the mechanism, which then permits a safe and controlled dismount of the container. The description of one said mechanism but not limited to is: A spring loaded locking shaft or bolt with a slanted end, mounted perpendicularly to the outside surface of the lift channel wall and of sufficient length and strength to stop the rotation of the lift tube channel (even when suspending a fully loaded wheeled waste cart) when this bolt is secured in a hole in the near wall of the receiver mount channel. This hole is formed at the bottom of a ramped trough that is secured to the receiver channel wall and contacts and faces the slanted end of the lock bolt. It is configured in such a way that when the bolt has been mechanically retracted slightly, and the lift tube is rotated, the force that is applied to the lift tube causes the ramp to push the slanted end of the lock bolt perpendicularly backward against spring pressure until this bolt is captured by a latch or mechanism and kept from rebounding back into the hole. The released channels can then pivot freely, and when rotated far enough the latch or mechanism holding the spring loaded lock bolt is tripped, freeing the bolt to return to the hole when two align. The two channels will remain locked until the bolt is again mechanically slightly retracted and rotational force again pushes the locking bolt back into its captured position, allowing again free rotation and repeating of cycle.

3. A household wheeled waste/recycling cart lifting and transporting device for use in conjunction with a receiver type trailer hitch, with or without a ball mount, and with or without a hitch ball comprising:
Any device or mechanism used to lift and transport household waste/recycling wheeled containers that utilizes a mechanically attached, separate, removable and adjustable lifting member. Said member is unique for this purpose or application in that it is:
a. Made with a specially designed notch or slot to receive the cross bar of most types of household wheeled waste/recycling carts. The description of one said notch or slot but not limited to is, a stepped shaped slot to receive and secure the lift bar of most wheeled household waste/recycling carts. The leading edge opening of the lift tube slot has a knifed or wedge shaped edge. The outer leading edge of this wedge accomplishes self-alignment of the lift tube with the cart lift bar. The angle of this wedge permits the lift tube to slide easily upward during loading rather than dead-ending (digging) into the body of the cart and stopping the forward momentum applied to the cart. Because of this design, the carts will smoothly load onto the lift and transport device at various cart approach angles. When this wedge makes contact with the cart, under the cross bar, the inside top of the wedge face also makes contact with the lift bar of the cart. This wedge angle forces or deflects the lift tube into the gap between the lift bar and the cart body, and with the forward motion of the cart forces the lift tube to align itself (mate with) the surface of the recessed channel in the cart body. At this point, the lift tube and the cart are parallel and the cart lift bar will slide down the slot in the lift tube and fully embody itself in the recess of the cart. The distance between the lift bar of the cart and the bottom of the recessed channel (body of cart) varies from brand and style of cart. This distance or gap between the lift bar and the cart body typically falls into two categories, a shallow gap and a deep gap style. When loaded into the lift tube, the shallow gapped cart lift bar comes to rest at the bottom of the first step of the lift slot. A deep gapped cart comes to rest at the bottom of the second step. This creates a tight fit between the lift tube and the cart body regardless of which type of cart is loaded.
b. Mates closely with the lift bar of the container/cart and a substantial length of the front surface, especially the length of the member that extends toward the top of the cart beyond the lift bar of the container. This creates a lifting lever, allowing the container to be leveraged on the pivot point of the device, reducing the force and effort needed to elevate the container and any contents off the ground and in to the locked position.
c. Contains a series of adjustment or re-position holes permitting the attached height of the lift member to be raised or lowered to compensate for different hitch heights and container crossbar heights.
d. Can be removed and replaced, so that if the crossbar of a new or unusual refuse cart design does not fit tightly in an existing lift member, the lift member can be changed, rather than modifying or replacing the whole refuse cart lift and transport device. This would enable manufacturers of the Recycling Cart Lifting and Transporting Device to adjust to evolving wheeled cart designs or move into markets where there are unique or unforeseen cart designs.
